(19) United States
(12) Patent Application Publication
(10) Pub. No.: US 2026/0048701 A1
(43) Pub. Date: Feb. 19, 2026

(54) PROVIDING ADVANCE WARNING OF BRAKING THROUGH EARLY ILLUMINATION OF A BRAKE LIGHT

(71) Applicant: Robert Bosch GmbH, Stuttgart (DE)

(72) Inventors: Martin Richter, Belleville, MI (US); Troy A. McCormick, Milford, MI (US); Christopher J. Kelly, LaSalle (CA); Courtney L. Lawson, Livonia, MI (US)

(21) Appl. No.: 18/802,966

(22) Filed: Aug. 13, 2024

(51) Int. Cl. B60Q 1/44

(52) U.S. Cl. CPC B60Q 1/44

(57) ABSTRACT

A system for providing advance warning of braking through early illumination of a brake light. The system includes a first electronic processor. The first electronic processor is configured to determine a braking event is likely to occur and, in response to determining that the braking event is likely to occur, generate a forward collision warning, a prefill request, or both and, prior to generating the forward collision warning, the prefill request, or both, generate a request to illuminate a brake light.

### SUMMARY

Many vehicles today are equipped with one or more adaptive driving assistance systems (ADASs) which aid drivers in controlling their vehicles by providing autonomous or partially autonomous functionality and guidance. For example, an ADAS may provide automatic emergency braking (AEB), adaptive cruise control (ACC), or the like. In some examples, ADAS functions provide warnings or directions to drivers. For example, when an electronic processor that implements an ADAS is included in an ego vehicle and the electronic processor determines that the ego vehicle may collide with a preceding object (for example, a vehicle), the electronic processor may generate a forward collision warning (FCW).

To prevent rear end collisions, it is advantageous that braking vehicles illuminate their brake light(s) as soon as there is a reasonable likelihood that a braking event will occur. In other words, it is advantageous to provide a following vehicle the maximum amount of advance notice that the ego vehicle will brake without generating enough false positives (instances of the ego vehicle's brake lights illuminating without the ego vehicle braking) that the driver of the following vehicle begins to ignore the illumination of the brake lights of the ego vehicle. While the advantages of the implementations described herein are described as being applicable to following vehicles, in some cases, the advantages may also be applicable to nonmotorized vehicles (for example, bicycles) or pedestrians.

FIG. 1 provides an example illustration of when the illumination of brake lights traditionally occurs in vehicles equipped with an ADAS. As can be seen in FIG. 1, traditionally, the brake lights of a vehicle are only illuminated once brake torque has been built up. In FIG. 1, at block 100, an electronic processor of an ego vehicle may, while executing an ADAS function, determine that braking of the ego vehicle (either autonomous or driver initiated), is likely to occur in the near future. The electronic processor may make this determination based on data from one or more sensors (for example, one or more radar sensors, lidar sensors, cameras, or the like that are configured to collect data regarding the environment of the ego vehicle). In some implementations, at block 105, when the electronic processor executing the ADAS determines that braking of the ego vehicle is likely to occur in the near future, the electronic processor generates a forward collision warning, a prefill request, or both. In some implementations, the forward collision warning is output to the driver of the ego vehicle via an output device (for example, a speaker, a heads-up display, a haptic device, a combination of the foregoing, or the like). In some implementations, the prefill request causes a brake pad to move close to its corresponding brake disc so that the brake pad and its corresponding brake disc touch slightly, but not enough to cause deceleration of the ego vehicle. Prefilling allows the ego vehicle to brake more immediately in response to depression of a brake pedal or an autonomous braking command generated by an electronic processor included in the ego vehicle.

In some implementations, at block 110, the electronic processor included in the ego vehicle, when executing instructions to provide AEB or ACC (ADAS functions), generates a command to apply the brakes of the ego vehicle autonomously. In some implementations, at block 115, a command to apply the brakes of the ego vehicle is generated when a driver of the ego vehicle depresses the brake pedal of the ego vehicle. In response to the command generated at block 110, the command generated at block 115, or both, at block 120, brake torque may be built up to a level where the brakes are applied and the ego vehicle begins to slow. At block 125, once the brake torque has built up to a level at which the brakes of the ego vehicle are applied and the ego vehicle begins to slow, the brake lights of the ego vehicle are illuminated.

The implementations described herein allow, among other things, brake lights to be illuminated a few hundred milliseconds or, in some cases, up to one second earlier than they would be if they were illuminated in response to the brakes of the vehicle being applied (as illustrated above in FIG. 1), without generating a significant number of false positive illuminations of brake lights. When a following vehicle is traveling at a fast speed, providing a notification of stopping or slowing of the ego vehicle to the following vehicle or following vehicle's driver a few hundred milliseconds earlier, may mean the following vehicle or the following vehicle's driver has more time to react, and therefore decreases the likelihood that the following vehicle will collide with the ego vehicle. In some implementations, when multiple vehicles are following each other in a line, the delays of a following vehicle or a driver of a following vehicle in reacting to the deceleration of the preceding vehicle will build up. As a result, each successive following vehicle in the line will need to decelerate harder than the preceding vehicle. This build-up of delays is known as the platooning effect and can result in dangerous situations for vehicles farther down the line. Thus, implementations described herein, mitigate the platooning effect, allow following vehicles to react faster to a leading vehicle braking, and reduce the likelihood of rear end collisions.

One example implementation provides a system for providing advance warning of braking through early illumination of a brake light. The system includes a first electronic processor. The first electronic processor is configured to determine a braking event is likely to occur and, in response to determining that the braking event is likely to occur, generate a forward collision warning, a prefill request, or both and, prior to generating the forward collision warning, the prefill request, or both, generate a request to illuminate a brake light.

Another example implementation provides a method for providing advance warning of braking through early illumination of a brake light. The method includes determining, with a first electronic processor, a braking event is likely to occur and, in response to determining that the braking event is likely to occur, generating, with the first electronic processor, a forward collision warning, a prefill request, or both and, after generating the forward collision warning, the prefill request, or both, generating, with the first electronic processor, a request to illuminate a brake light.

Yet another example implementation provides a method for providing advance warning of braking through early illumination of a brake light. The method includes generating, with a first electronic processor, a forward collision warning, a prefill request, or both and, after generating the forward collision warning, the prefill request, or both, generating, with the first electronic processor, a request to illuminate a brake light of a vehicle when a request to autonomously brake the vehicle is generated.

### BRIEF DESCRIPTION OF THE DRAWINGS

FIG. 1 provides an example illustration of when the illumination of brake lights traditionally occurs in a vehicle equipped with an ADAS, in accordance with some implementations.

FIG. 2 illustrates an example system for providing advance warning of braking through early illumination of a brake light, in accordance with some implementations.

FIG. 3 provides an illustrative example of the components of an ADAS controller included in the system of FIG. 2, in accordance with some implementations.

FIG. 4 provides an illustrative example of the components of a brake controller included in the system of FIG. 2, in accordance with some implementations.

FIG. 5A and FIG. 5B provide flowcharts illustrating example methods for providing advance warning of braking through early illumination of a brake light, in accordance with some implementations.

FIG. 6 provides a detailed flowchart illustrating when the illumination of a brake light occurs in a vehicle implementing a method for providing advance warning of braking through early illumination of a brake light compared to when the illumination of a brake light traditionally occurs in a vehicle equipped with an ADAS, in accordance with some implementation.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

In this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

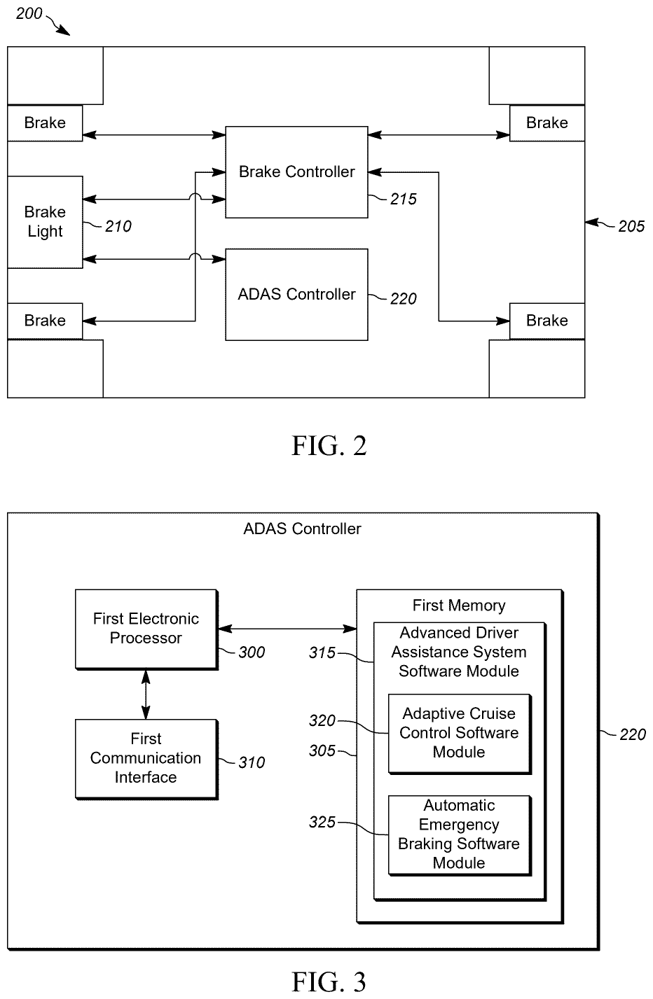

FIG. 2 illustrates an example system 200 for providing advance warning of braking through early illumination of a brake light. In FIG. 2 the system 200 includes a vehicle 205. While the vehicle 205 is illustrated in FIG. 2 as being a four-wheel vehicle, it should be understood that the vehicle 205 may be a two wheeled vehicle, a three wheeled vehicle, a six wheeled vehicle or the like. Additionally, while the vehicle 205 is illustrated as having a brake associated with each wheel, a brake need not be associated with each wheel of the vehicle 205.

The vehicle 205 may also include brake light 210. While the brake light 210 is illustrated in FIG. 2 as a single block, it should be understood that the vehicle 105 may include any number of brake lights arranged in one of any of number of positions. For example, the vehicle 205 may include two brake lights positioned at the rear of the vehicle 205, one brake light positioned on the passenger side of the vehicle 205 and the other positioned on the driver side of the vehicle 205. The vehicle 205 may include one or more controllers. The vehicle 205 illustrated in FIG. 2 includes a brake controller 215 and an ADAS controller 220. In some implementations, the vehicle 205 includes a single controller that is configured to perform the functionality described herein as being performed by the brake controller 215 and the ADAS controller 220. In other implementations, the functionality described as being implemented by the brake controller 215 is implemented by multiple controllers. Likewise, the functionality described as being implemented by the ADAS controller 220 may be implemented by multiple controllers. In some implementations, the vehicle 205 includes one or more sensors. In some implementations, some or all of the functionality described herein may be performed by an electronic controller associated with a sensor included in the vehicle 205.

The components of the vehicle 205, are electrically and communicatively coupled to each other via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all the components of the vehicle 205 may be communicatively coupled using suitable wireless modalities (for example, Bluetooth™ or near field communication connections).

FIG. 3 provides an illustrative example of the components of the ADAS controller 220. In the example illustrated in FIG. 3, the ADAS controller 220 includes a first electronic processor 300 (for example, a microprocessor, application specific integrated circuit, etc.), a first memory 305, and a first communication interface 310. The first memory 305 may be made up of one or more non-transitory computer-readable media. The first memory 305 can include combinations of different types of memory, such as read-only memory (“ROM”), random access memory (“RAM”), electrically erasable programmable read-only memory (“EEPROM”), flash memory, or other suitable memory devices. The first electronic processor 300 is coupled to the first memory 305 and the first communication interface 310. The first electronic processor 300 sends and receives information (for example, from the first memory 305 and/or the first communication interface 310) and processes the information by executing one or more software instructions or modules, capable of being stored in the first memory 305, or another non-transitory computer readable medium. The software can include firmware, one or more applications, program data, filters, rules, one or more program modules, and other executable instructions. The first electronic processor 300 is configured to retrieve from the first memory 305 and execute, among other things, software for performing methods as described herein. In the example illustrated, the first memory 305 stores, among other things, an ADAS software module 315. The ADAS software module 315 may include an ACC software module 320 and an AEB software module 325. The first communication interface 310 transmits and receives information from devices external to the ADAS controller 220 (for example, the brake controller 215 and the brake light 210).

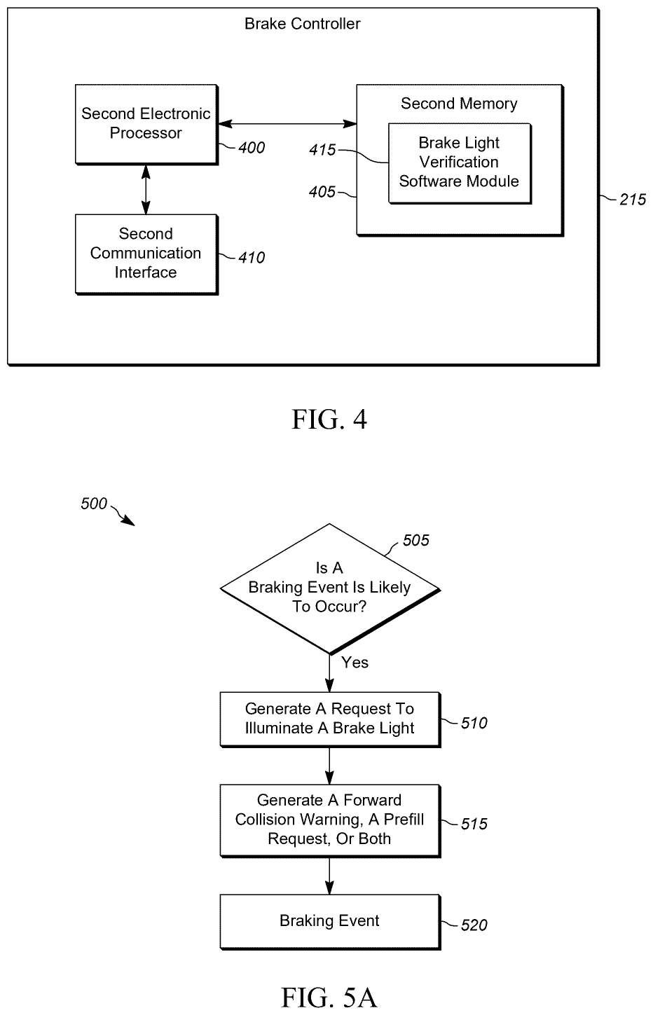

FIG. 4 provides an illustrative example of the components of the brake controller 215. In some implementations, the brake controller 215 includes a second electronic processor 400, a second memory 405, and a second communication interface 410. In some implementations, the components and connections of the brake controller 215 are similar to the components and connections included in the ADAS controller 220. However, unlike the first memory 305 of the ADAS controller 220, the second memory 405 of the brake controller 215 may include a brake light verification software module 415, rather than the ADAS software module 315. In some implementations, the second memory 405 also includes software that, when executed by the second electronic processor 400, allows the brake controller 215 to control the brakes of the vehicle 205.

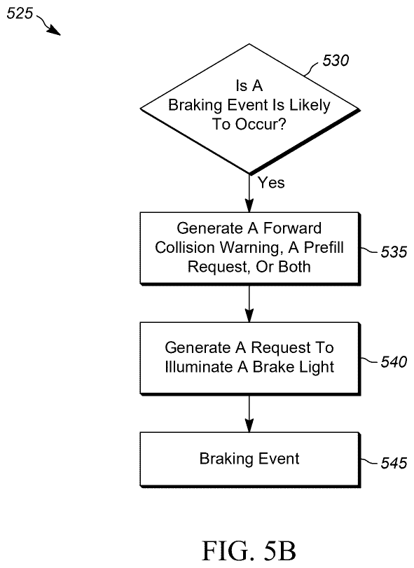

FIG. 5A and FIG. 5B are flowcharts illustrating example methods for providing advance warning of braking through early illumination of a brake light. In some implementations, method 500 of FIG. 5A begins at block 505 when the first electronic processor 300 determines whether a braking event is likely to occur. The first electronic processor 300 may determine that a braking event is likely to occur as a part of implementing an ADAS function (including, for example, ACC functionality and AEB functionality). For example, the first electronic processor 300 may determine that a braking event is likely to occur when the first electronic processor 300 executes the adaptive cruise control software module 320, the automatic emergency braking software module 325, or both. In some implementations, the first electronic processor 300 may determine that a braking event is likely to occur based on data received from one or more sensors included in the vehicle 205 (for example, one or more radar sensors, lidar sensors, cameras, or the like that are configured to collect data regarding the environment of the vehicle 205). In some implementations, at block 505, the first electronic processor 300 determines a braking event is likely to occur in the near future or within a predetermined time period from the current time (for example, within the next minute, the next 30 seconds, or the like). In one illustrative example, the first electronic processor 300 determines that a braking event is likely to occur in the near future when, based on image data and speedometer data, the first electronic processor 300 determines that the vehicle 205 is traveling 50 miles per hour and is 100 feet behind a vehicle traveling 35 miles per hour in the same lane and direction as the vehicle 205.

In some implementations, in response to determining that a braking event is likely to occur, at block 510, the first electronic processor 300 generates a request to illuminate a brake light (for example, the brake light 210). At block 515, the first electronic processor 300 generates a forward collision warning, a prefill request, or both. Finally, at block 520, the braking event occurs.

In some implementations, a braking event includes braking the vehicle 205 in response to a depression of a brake pedal (not illustrated) of the vehicle 205. In some implementations, a braking event includes braking the vehicle 205 in response to receiving a braking request from the first electronic processor 300. For example, the second electronic processor 400 may receive a braking request from the first electronic processor 300 and, in response to receiving the braking request, apply the brakes of the vehicle 205, without input from an operator or driver of the vehicle 205 (in other words, brake the vehicle 205 autonomously). It should be understood that the method 500 need not include block 520. In some instances, blocks 505-515 are performed by the first electronic processor 300 without a braking event occurring because, for example, the vehicle 205 changes lanes suddenly, the first electronic processor 300 erroneously determined a braking event was likely to occur due to sensor malfunction, or the like. However, block 520 is illustrated in FIG. 5A to highlight that the first electronic processor 300 generates the request to illuminate the brake light 210 prior to the braking event occurring.

It should be noted that, in the method 500, the first electronic processor 300 generates the request to illuminate the brake light 210 prior to the braking event occurring (prior to the vehicle 205 braking) and prior to the first electronic processor 300 generating a forward collision warning, a prefill request, or both.

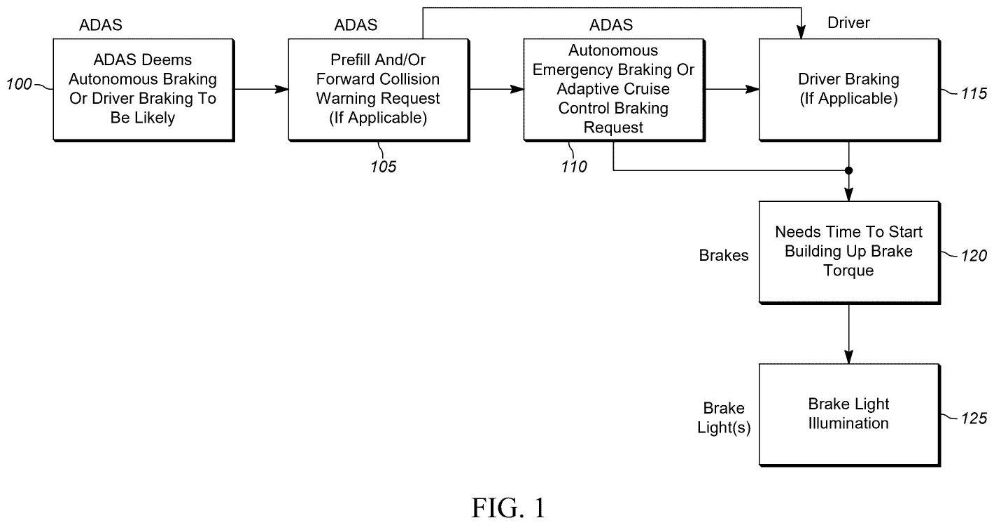

As described above with relation to FIG. 1, in some implementations, the forward collision warning is output to the driver of the vehicle 205 via an output device (for example, a speaker, a heads-up display, a haptic device, a combination of the foregoing, or the like) (not illustrated). In some implementations, the prefill request causes a brake block to move close to its corresponding brake disc so that the brake block and its corresponding brake disc touch slightly, but not enough to cause deceleration of the vehicle 205.

The method 525 illustrated in FIG. 5B is similar to the method 500. As in the method 500, the method 525 begins at block 530 when the first electronic processor 300 determines whether a braking event is likely to occur and, in response to determining that a braking event is likely to occur, the first electronic processor 300 proceeds to perform the functionality described in relation to blocks 535 and 540. However, in the method 525, the first electronic processor 300, at block 540, generates a request to illuminate a brake light after generating a forward collision warning, a prefill request, or both at block 535. After the first electronic processor 300 generates a request to illuminate a brake light (for example, the brake light 210), at block 545, the braking event occurs.

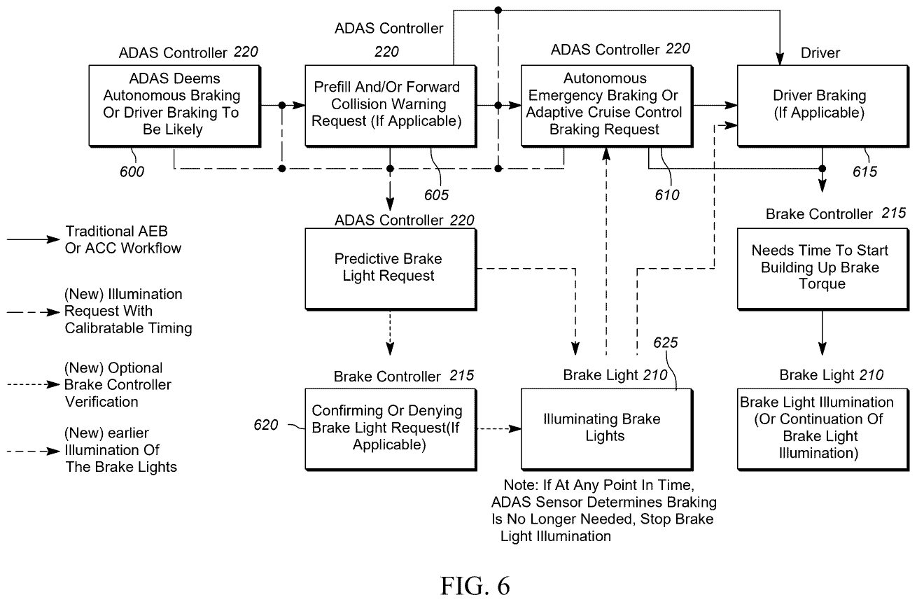

FIG. 6 provides a detailed flowchart illustrating when the illumination of a brake light occurs in vehicles implementing a method for providing advance warning of braking through early illumination of a brake light compared to when the illumination of a brake light traditionally occurs in vehicles equipped with an ADAS. In FIG. 6, the solid connectors represent when the illumination of a brake light traditionally occurs in vehicles equipped with an ADAS. When the illumination of a brake light traditionally occurs in vehicles equipped with an ADAS is described in detail above with reference to FIG. 1.

In FIG. 6, the connectors with alternating long and short dashes represent when a request to illuminate a brake light may be generated in order to provide advance warning of braking through early illumination of the brake light, as described herein. As illustrated in FIG. 6, a request to illuminate a brake light may be generated at any one of a plurality of times and, in some implementations, a manufacturer of the vehicle 205 may choose one of the plurality of times as the time when a request to illuminate a brake light may be generated. In other words, the timing of the request to illuminate the brake light is calibratable. For example, in some implementations, a request to illuminate a brake light is generated at block 600 when the first electronic processor 300 determines a braking event is likely to occur. The request to illuminate a brake light may also be generated after the first electronic processor 300 determines a braking event is likely to occur but before the first electronic processor 300 generates a forward collision warning, a prefill request, or both at block 605. In some implementations, the first electronic processor 300 generates the request to illuminate a brake light at block 605 when the first electronic processor 300 generates the forward collision warning, the prefill request, or both. In some implementations, the first electronic processor 300 generates the request to illuminate a brake light after generating the forward collision warning, the prefill request, or both at block 605 but before generating a request to autonomously brake the vehicle 205 at block 610 or before a driver of the vehicle 205 depresses a brake pedal of the vehicle 205 at block 615, in response to, for example, the forward collision warning. In some implementations, the first electronic processor 300 generates the request to illuminate a brake light when a request to autonomously brake the vehicle 205 is generated at block 610.

In some implementations, the first electronic processor 300 is not configured to implement the functionality described in each of block 600, block 605, and block 610. For example, the first electronic processor 300 may not determine that a braking event is likely at block 600 and only perform the functionality described in relation to blocks 605 and 610. In this example, the first electronic processor 300 generates the request to illuminate a brake light at block 605, at block 610, in between block 605 and 610, or in between block 605 and 615. In another example, the first electronic processor 300 does not generate a forward collision warning or generate a prefill request at block 605 and only performs the functionality described in relation to blocks 600 and 610.

As illustrated by block 620 and the finely dashed connectors, in some implementations, in response to receiving the request to illuminate the brake light, the second electronic processor 400, when executing, for example, the brake light verification software module 415, confirms or denies the request to illuminate the brake light. In one example, the second electronic processor 400 may deny the request to illuminate the brake light when a system failure (for example, a hardware or software failure of a component involved in implementing the functionality described herein) is occurring. A system failure may occur when an electronic processor, actuator, or sensor that is relied on to perform an ADAS function fails (for example, when a solenoid in the brake controller 215 fails and cannot be controlled). A system failure may also occur due to a short circuit, an open circuit, a low voltage, or a high voltage.

In another example, the second electronic processor 400 may deny the request to illuminate the brake light when the second electronic processor 400 determines that braking is unsafe due the brakes overheating in response to a high of frequency of braking requests or a length of a braking request.

In yet another example, the second electronic processor 400 may deny the request to illuminate the brake light when the request is received less than a predetermined amount of time from when the most previous request to illuminate the brake light was received. In some implementations, the second electronic processor 400 may deny the request to illuminate the brake light due to security concerns (for example, when the second electronic processor 400 has recently experienced a loss of communication with the first electronic processor 300, when the second electronic processor 400 does not receive a cyclic redundancy check (CRC) message from the first electronic processor 300, when the second electronic processor 400 does not receive a heartbeat signal from the first electronic processor 400, or the like). In some implementations, the second electronic processor 400 may deny the request to illuminate the brake light when the second electronic processor 400 receives conflicting requests, when a diagnostic error message (for example, a DTC (Diagnostic Trouble Code) or OBD-II (on-board diagnostic)) is received, or the like.

In response to confirming the request to illuminate a brake light, the second electronic processor 400 may send the request to illuminate the brake light to the brake light 210 of the vehicle 205. In some implementations, the request to illuminate the brake light sent by the second electronic processor 400 is a request to illuminate the brake light by repeatedly flashing the brake light in rapid succession. In other implementations, the request to illuminate the brake light sent by the second electronic processor 400 is a request to illuminate the brake light in a solid manner (for example, with-out repeatedly flashing, successively brightening and dimming, or the like).

In some implementations, when the brake light 210 is illuminated early and no request to autonomously brake the vehicle 205 is received from the first electronic processor 300 within a predetermined time period from the illumination of the brake light 210 (for example, within 2 seconds of the brake light 210 being illuminated early) and the brake pedal included in the vehicle 205 is not depressed within the predetermined time period from the illumination of the brake light 210, the illumination of the brake light 210 ceases. In some implementations, when the brake light 210 is illuminated early and a request to autonomously brake the vehicle 205 is received from the first electronic processor 300 within a predetermined time period from the illumination of the brake light 210 (represented by the coarsely dashed connector between block 625 and block 610), the brake pedal included in the vehicle 205 is depressed within the predetermined time period from the illumination of the brake light 210 (represented by the coarsely dashed connector between block 625 and block 615), or a combination of the foregoing, the illumination of the brake light 210 continues. After the brakes of the vehicle 205 are applied, illumination of the brake light 210 may also cease when the brakes of the vehicle 205 are no longer being applied.

Thus, examples, aspects, and features herein provide, among other things, systems and methods providing advance warning of braking through early illumination of a brake light.

What is claimed is:

1. A system for providing advance warning of braking through early illumination of a brake light, the system comprising:
a first electronic processor, the first electronic processor configured to:
determine a braking event is likely to occur; and
in response to determining that the braking event is likely to occur,
generate a forward collision warning, a prefill request, or both; and
prior to generating the forward collision warning, the prefill request, or both, generate a request to illuminate a brake light.

2. The system according to claim 1, wherein the braking event is at least one selected from the group consisting of braking a vehicle in response to a depression of a brake pedal of the vehicle and braking the vehicle in response to receiving a braking request from the first electronic processor.

3. The system according to claim 1, wherein the first electronic processor is further configured to:
send the request to illuminate the brake light to a second electronic processor included in a braking controller, wherein the second electronic processor is configured to control a brake of a vehicle.

4. The system according to claim 3, wherein the second electronic processor is configured to:
in response to receiving the request to illuminate the brake light, confirm or deny the request to illuminate the brake light; and
in response to confirming the request to illuminate the brake light, send the request to illuminate the brake light to the brake light of the vehicle.

5. The system according to claim 1, wherein the first electronic processor is included in an adaptive driving assistance system controller.

6. The system according to claim 1, wherein the first electronic processor is further configured to implement adaptive cruise control and automatic emergency braking.

7. The system according to claim 1, wherein the first electronic processor is configured to generate the forward collision warning, the prefill request, or both prior to the braking event.

8. A method for providing advance warning of braking through early illumination of a brake light, the method comprising:
determining, with a first electronic processor, a braking event is likely to occur; and
in response to determining that the braking event is likely to occur,
generating, with the first electronic processor, a forward collision warning, a prefill request, or both; and
after generating the forward collision warning, the prefill request, or both, generating, with the first electronic processor, a request to illuminate a brake light.

9. The method according to claim 8, wherein after generating a forward collision warning, the prefill request, or both, generating, with the first electronic processor, a request to illuminate a brake light includes:
generating the request to illuminate the brake light when a request to autonomously brake a vehicle is generated by the first electronic processor.

10. The method according to claim 8, wherein the braking event is at least one selected from the group consisting of braking a vehicle in response to a depression of a brake pedal of the vehicle and braking the vehicle in response to receiving a braking request from the first electronic processor.

11. The method according to claim 8, wherein the method further includes:
sending the request to illuminate the brake light to a second electronic processor included in a braking controller, wherein the second electronic processor is configured to control a brake of a vehicle.

12. The method according to claim 11, wherein the method further includes:
in response to receiving the request to illuminate the brake light, confirming or denying, with the second electronic processor, the request to illuminate the brake light; and
in response to confirming the request to illuminate the brake light, sending, with the second electronic processor, the request to illuminate the brake light to the brake light of the vehicle.

13. The method according to claim 8, wherein the first electronic processor is included in an adaptive driving assistance system controller.

14. The method according to claim 8, wherein the first electronic processor is configured to implement adaptive cruise control and automatic emergency braking.

15. The method according to claim 8, wherein generating the forward collision warning, the prefill request, or both includes:
generating the forward collision warning, the prefill request, or both prior to the braking event.

16. A method for providing advance warning of braking through early illumination of a brake light, the method comprising:
generating, with a first electronic processor, a forward collision warning, a prefill request, or both; and
after generating the forward collision warning, the prefill request, or both, generating, with the first electronic processor, a request to illuminate a brake light of a vehicle when a request to autonomously brake the vehicle is generated.
